(19) United States
(12) Patent Application Publication
(10) Pub. No.: US 2014/0165391 A1
(43) Pub. Date: Jun. 19, 2014

(54) METHOD FOR ARRANGING CURRENT CELLS OF A CURRENT SOURCE

(71) Applicant: Realtek Semiconductor Corp., HsinChu (TW)

(72) Inventor: Shan-Chih Tsou, Hsinchu City (TW)

(21) Appl. No.: 13/927,121

(22) Filed: Jun. 26, 2013

(30) Foreign Application Priority Data
Dec. 13, 2012 (TW) 101147258

(51) Int. Cl. H02J 4/00

(52) U.S. Cl. CPC H02J 4/00
USPC 29/825

(57) ABSTRACT

A method for arranging current cells of a current source includes sequentially arranging a plurality of current cells of the current source to form a first sort; executing interval exchange arrangement on the first sort to form a second sort according to characteristics of the current cells providing a first current or a second current; executing interval exchange arrangement on the second sort to form a third sort; and determining positions of the current cells to form a current cell row according to the third sort.

### BACKGROUND OF THE INVENTION

1. Field of the Invention

The present invention relates to a method for arranging current cells of a current source, where the method can increase balance and linearity of the current source.

2. Description of the Prior Art

In the prior art, a current-steering digital to analog converter has current cells, where match level between the current cells directly influences balance and linearity of the current-steering digital to analog converter. Balance and linearity of the current-steering digital to analog converter can be defined according to equation (1) and equation (2), respectively.

$$\begin{matrix}Unbalance = \frac{{V}_{p} - {V}_{n}}{{V}_{n}} \times 100 \% & ( 1 ) \\ Nonlinearity = \sqrt{{\sum }_{i} {( {INL}_{i} )}^{2}} \\ {INL}_{i} = {I}_{real} - {I}_{ideal} & ( 2 )\end{matrix}$$

The match level between the current cells relates to sizes, spacing, and direction gradient of the current cells. Therefore, the match level between the current cells can be improved through a layout method.

FIG. 1A is a diagram illustrating layout of current cells 100-108 according to the prior art, and FIG. 1B is a diagram illustrating utilizing predetermined layout to solve a match problem between the current cells 100-108 according to the prior art. As shown in FIG. 1A, a layout environment surrounding of each current cell of the current cells 100-108 is different, so each practical current cell size of the current cells 100-108 is different, resulting in match level between the current cells 100-108 is lower. Therefore, as shown in FIG. 1B, a layout environment surrounding of each current cell of the current cell 101-108 is the same as a layout environment surrounding of the current cell 100 by adding 16 dummy current cells surrounding the current cell 101-108 to improve the match level between the current cells 100-108 in FIG. 1A. Although a layout of the current cells 100-108 in FIG. 1B can improve the match level between the current cells 100-108 in FIG. 1A due to a process factor, the layout of the current cells 100-108 in FIG. 1B wastes huge chip area.

FIG. 2 is a diagram illustrating another method for improving match level between current cells according to the prior art, where the method is called “Square Layout” method. The method in FIG. 2 closely arranges the current cells, so the method in FIG. 2 can reduce spacing influence between the current cells, direction gradient influence of the current cells, and mismatch between the current cells due to process variation by centralizing locations of the current cells. However, the “Square Layout” method is less flexible, so that chip area of the current cells is difficultly to shrink.

FIG. 3 is a diagram illustrating utilizing a “Random swap” method to improve match level between current cells C1-C16 according to the prior art. The “Random swap” method randomly lays out the current cells C1-C16, that is, the “Random swap” method utilizes random mismatch of the current cells C1-C16 to overcome unbalance and nonlinearity of the current cells C1-C16 due to spacing and direction gradient of the current cells C1-C16. However, the “Random swap” method can still not solve process mismatch due to spacing and direction gradient of the current cells C1-C16, so yield of the current cells C1-C16 may be influenced easily.

### SUMMARY OF THE INVENTION

An embodiment provides a method of arranging current cells of a current source. The method includes sequentially arranging a plurality of current cells included in the current source to form a first sort; executing interval exchange arrangement on the first sort to form a second sort according to characteristics of the plurality of current cells providing a first current or a second current; executing interval exchange on the second sort to form a third sort; and determining positions of the plurality of current cells to form a current cell row according to the third sort.

Another embodiment further provides a method of arranging current cells of a current source for determining a sort of a plurality of current cell rows. The method includes arranging a plurality of current cells included in the current source to M current cell rows to form a first sort, wherein each current cell row of the M current cell rows includes N current cells; executing interval exchange arrangement on the first sort to form a second sort according to a characteristic of each current cell of the plurality of current cells providing a first current or a second current; executing interval exchange on the second sort to form a third sort; and determining positions of the plurality of current cells according to the third sort; where M and N are positive integers greater than 1.

Another embodiment installs balance units or dummy current cells outside current cells to further improve balance and linearity of a current source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating layout of current cells according to the prior art.

FIG. 1B is a diagram illustrating utilizing predetermined layout to solve a match problem between the current cells according to the prior art.

FIG. 2 is a diagram illustrating another method for improving match level between current cells according to the prior art.

FIG. 3 is a diagram illustrating utilizing a “Random swap” method to improve match level between current cells according to the prior art.

FIG. 4 is a flowchart illustrating a method for increasing balance and linearity of a current source according to an embodiment.

FIG. 5, FIG. 6, and FIG. 7 are diagrams illustrating the current source corresponding to steps in FIG. 4.

FIG. 8 and FIG. 9 are diagrams illustrating how to apply the present invention to a plurality of current cell rows according to another embodiment.

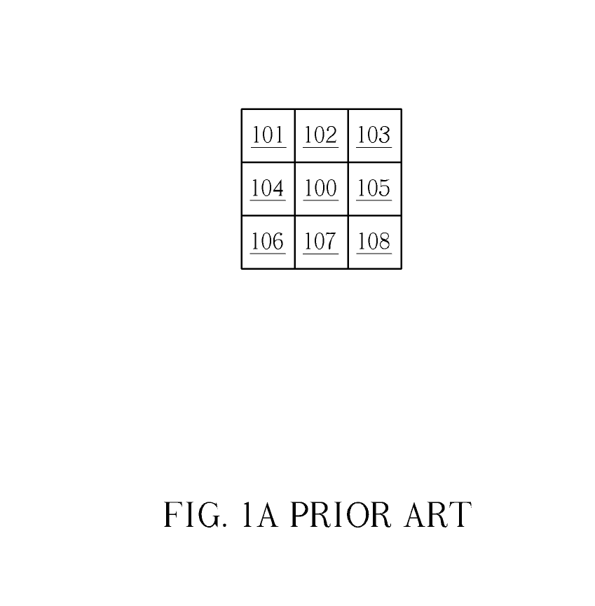

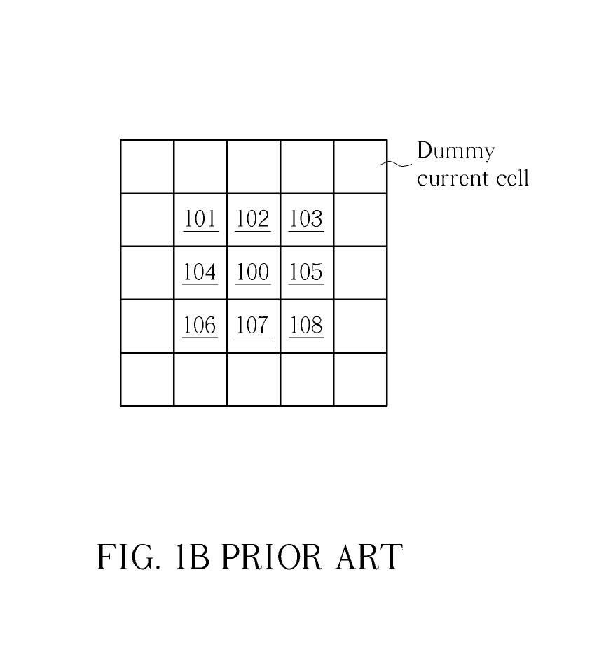

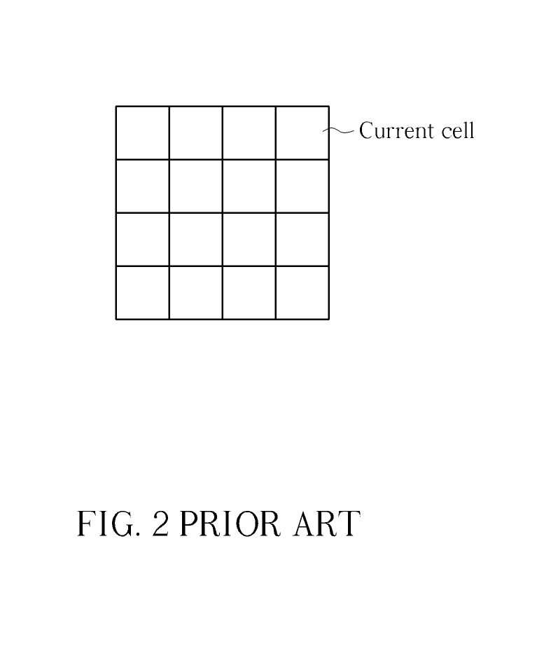

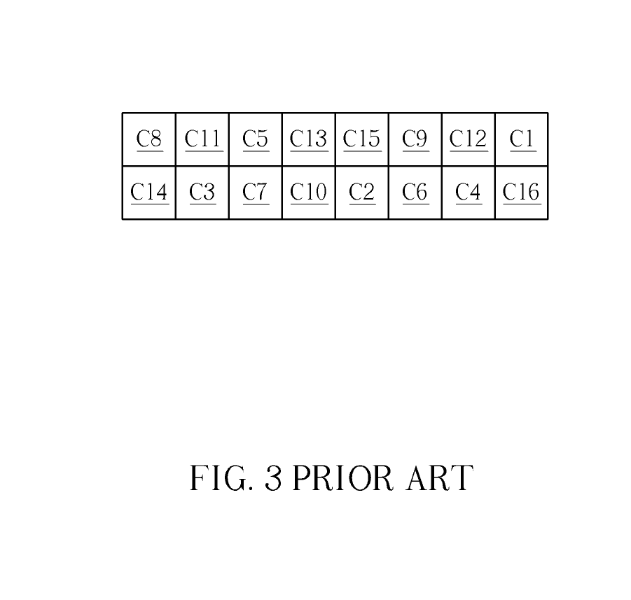

### DETAILED DESCRIPTION

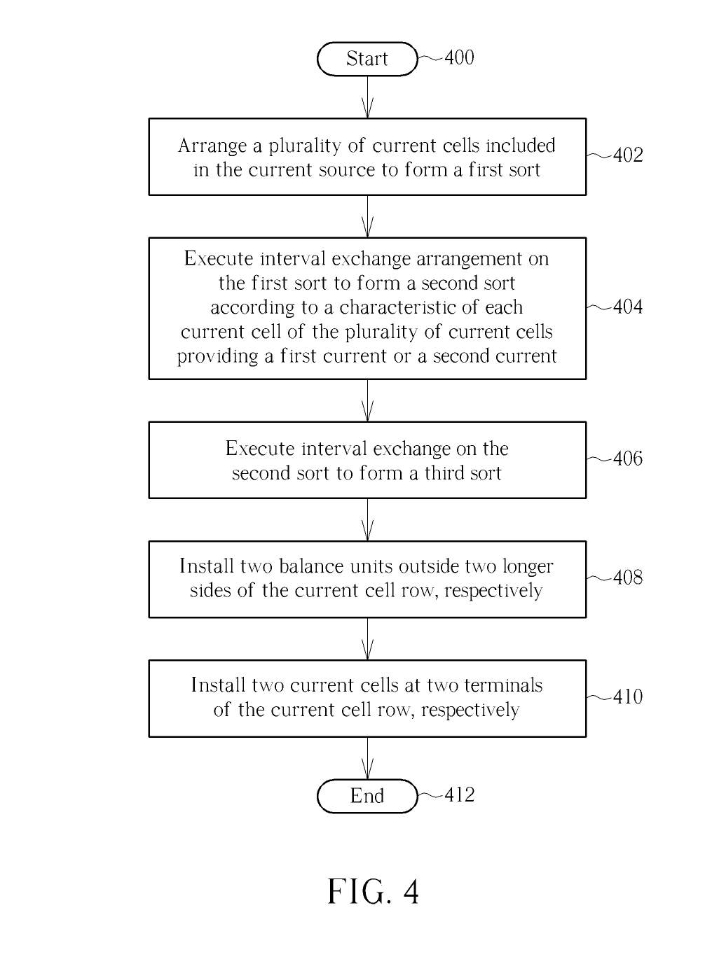

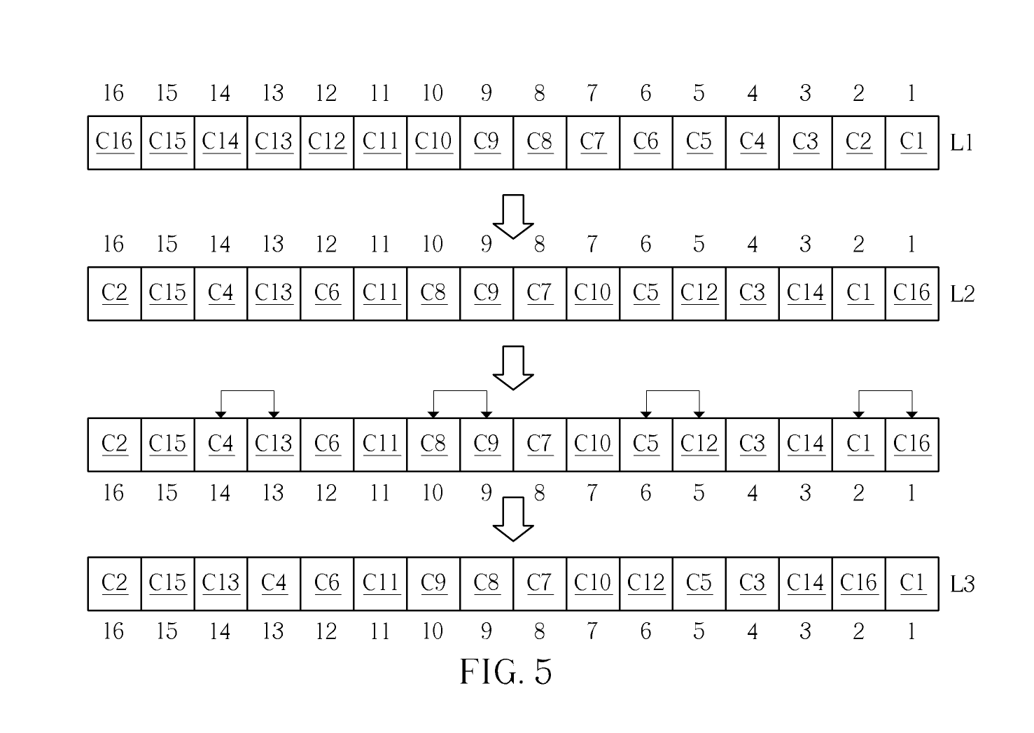

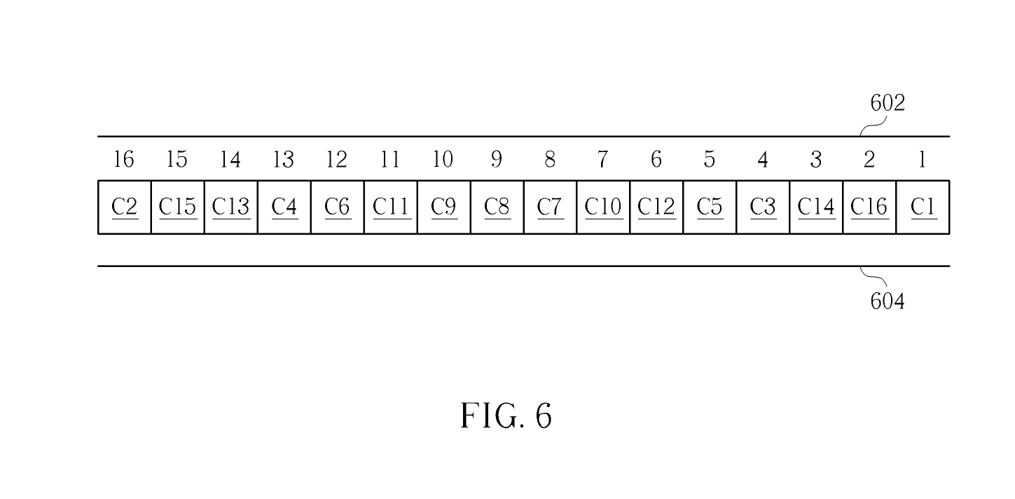

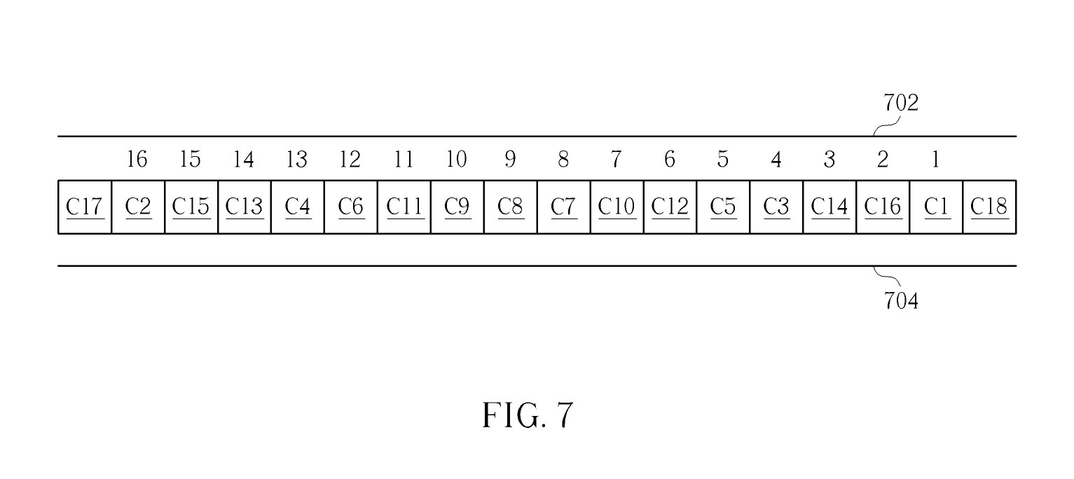

FIG. 4 is a flowchart illustrating a method for increasing balance and linearity of a current source according to an embodiment, and FIG. 5 is a diagram illustrating the current source corresponding to steps in FIG. 4. Detailed steps are as follows:

Step 400: Start.

Step 402: Arrange a plurality of current cells included in the current source to form a first sort L1.

Step 404: Execute interval exchange arrangement on the first sort L1 to form a second sort L2 according to a characteristic of each current cell of the plurality of current cells providing a first current or a second current.

Step 406: Execute interval exchange on the second sort L2 to form a third sort L3.

Step 408: Install two balance units 602 and 604 outside two longer sides of the current cell row, respectively.

Step 410: Install two current cells C17 and C18 at two terminals of the current cell row, respectively.

Step 412: End.

Please refer to FIG. 5. The embodiment takes 16 current cells C1-C16 in FIG. 5 as an example. In Step 402, the current cell C1-C16 are sequentially arranged to form the first sort L1. Meanwhile, the current cell C1 is placed on a position 1, the current cell C2 is placed on a position 2, and so on. In addition, as shown in FIG. 5, the current cells C1-C8 are used for providing the first current, and the current cells C9-C16 are used for providing the second current, where the first current is a positive current, and the second current is a negative current.

Please further refer to FIG. 5. In Step 404, the first sort L1 is executed the interval exchange arrangement to determine the second sort L2 of the current cells C1-C16 according to a characteristic of each current cell of the plurality of current cells providing the first current or the second current. As shown in FIG. 5, the current cell 16 is placed on the position 1, the current cell 15 is still placed on a position 15, the current cell 14 is placed on a position 3, the current cell 13 is still placed on a position 13, the current cell 12 is placed on a position 5, the current cell 11 is still placed on a position 11, the current cell 10 is placed on a position 7, the current cell 9 is still placed on a position 9, the current cell 8 is placed on a position 10, the current cell 7 is placed on a position 8, the current cell 6 is placed on a position 12, the current cell 5 is placed on a position 6, the current cell 4 is placed on a position 14, the current cell 3 is placed on a position 4, the current cell 2 is placed on a position 16, and the current cell 1 is placed on the position 2 to form the second sort L2. The interval exchange arrangement in Step 404 can reduce direction mismatch due to process gradient.

It is noted that the present invention is not limited to the current cells C1-C8 providing the positive current and the current cells C9-C16 providing the negative current. That is to say, the current cells C1-C8 can also provide the negative current. Meanwhile, the current cells C9-C16 provide the positive current. In addition, the present invention can be applied to arrangement of more or less current cells.

In Step 406, apart select a first current cell group (the current cell C1 and the current cell C16), a third current cell group (the current cell C5 and the current cell C12), a fifth current cell group (the current cell C8 and the current cell C9), and a seventh current cell group (the current cell C4 and the current cell C13) of the second sort L2 from right to left, and change positions of current cells of each current cell group of the four current cell groups respectively to complete the interval exchange in Step 406 to form the third sort L3. Thus, positions of the current cells C1-C16 can be determined to form a current cell row according to the third sort L3.

The interval exchange in Step 406 can prevent the current cells in the same side (e.g. the right side or the left side) of the current cell row from providing the positive current or the negative current. Thus, balance of the current source can be improved.

Balance and linearity of the current source can be determined according to equation (3) and equation (4), respectively:

$$\begin{matrix}\begin{matrix}Unbalance = \frac{{V}_{p} - {V}_{n}}{{V}_{n}} * 100 \% \\ = \frac{( {I}_{p} - {I}_{n} ) * R}{{I}_{n} * R} * 100 \% \\ = \frac{( {I}_{p} - {I}_{n} )}{{I}_{n}} * 100 \% = \frac{( {\sum }_{i = 9 \sim 16}^{ } {I}_{i} - {\sum }_{i = 1 \sim 8}^{ } {I}_{i} )}{{\sum }_{i = 1 \sim 8}^{ } {I}_{i}} * 100 \%\end{matrix} \\ \begin{matrix}{INL}_{i} = {I}_{codei} - {I}_{ideal\_codei} \\ = \begin{matrix}{\sum }_{k = 9 \sim i}^{ } {I}_{k} - ( k - 8 ) I & if i \geq 9\end{matrix} \\ \begin{matrix}{\sum }_{k = i \sim 8}^{ } {I}_{k} - ( 9 - k ) I & if i < 9\end{matrix}\end{matrix} & ( 3 ) \\ Nonlinearity = {( {INL}_{i} )}_{rms} = \sqrt{\frac{{\sum }_{i = 1 \sim 16}^{ } {( {INL}_{i} )}^{2}}{16}} & ( 4 )\end{matrix}$$

Current variation (represented as dI) of each current cell (providing a current I) of the current source from left to right due to process mismatch can be represented as parameters as follows:

I+−7dI, I+−6dI, I+−5dI, I+−4dI, I+−3dI, I+−2dI, I+−1dI, I, I+−1dI, I+−2dI, I+−3dI, I+−4dI, I+−5dI, I+−6dI, I+−7dI, I+'18dI

Before the current source is not executed the interval exchange arrangement in Step 404 and the interval exchange in Step 406, substituting the above mentioned parameters of the current source in FIG. 5 into equation (3) and equation (4) can yield corresponding balance and linearity of the current source according to equation (5) and equation (6):

$$\begin{matrix}Unbalance = \frac{( 8 I \pm 28 dI ) - ( 8 I \pm 36 dI )}{( 8 I \pm 36 dI )} * 100 \% & ( 5 ) \\ {( INL )}_{rms} = \sqrt{\frac{2 * [ {( dI )}^{2} + {( 3 dI )}^{2} + {( 6 dI )}^{2} + {( 10 dI )}^{2} + {( 15 dI )}^{2} + {( 21 dI )}^{2} + {( 28 dI )}^{2} ] + {( 36 dI )}^{2}}{16}} & ( 6 )\end{matrix}$$

As shown in equation (5) and equation (6), maximum unbalance of the current source is

$$\frac{64 dI}{8 I - 36 dI} * 100 \%$$

and maximum nonlinearity is 16.748 (dI).

After the current source is executed the interval exchange arrangement in Step 404 and the interval exchange in Step 406, substituting the above mentioned parameters of the current source in FIG. 5 into equation (3) and equation (4) can yield corresponding balance and linearity of the current source according to equation (7) and equation (8):

$$\begin{matrix}Unbalance = \frac{( 8 I \pm 32 dI ) - ( 8 I \pm 32 dI )}{( 8 I \pm 32 dI )} * 100 \% & ( 7 ) \\ {( INL )}_{rms} = \sqrt{\frac{[ {( dI )}^{2} + {( 3 dI )}^{2} + {( 5 dI )}^{2} + {( 8 dI )}^{2} + {( 13 dI )}^{2} + {( 19 dI )}^{2} + {( 25 dI )}^{2} + {( 32 dI )}^{2} ]}{16}} + \sqrt{\frac{[ {( dI )}^{2} + {( 4 dI )}^{2} + {( 8 dI )}^{2} + {( 12 dI )}^{2} + {( 17 dI )}^{2} + {( 24 dI )}^{2} + {( 32 dI )}^{2} ]}{16}} & ( 8 )\end{matrix}$$

As shown in equation (7) and equation (8), maximum unbalance of the current source is

$$\frac{64 dI}{8 I - 32 dI} * 100 \%$$

and maximum nonlinearity is 16.568 (dI).

Current variation (represented as dI) of each current cell (providing the current I) of the current source from left to right due to process gradient can be represented as parameters as follows:

I−3.5dI, I−3dI, I−2.5dI, I−2dI, I−1.5d1, I−1dI, I−0.5dI, I, I+0.5dI, I+1dI, I+1.5dI, I+2dI, I+2.5dI, I+3dI, I+3.5dI, I+4dI

Before the current source is not executed the interval exchange arrangement in Step 404 and the interval exchange in Step 406, substituting the above mentioned parameters of the current source in FIG. 5 into equation (3) and equation (4) can yield corresponding balance and linearity of the current source according to equation (9) and equation (10):

$$\begin{matrix}Unbalance = \frac{( 8 I - 14 dI ) - ( 8 I + 18 dI )}{( 8 I + 18 dI )} * 100 \% & ( 9 ) \\ {( INL )}_{rms} = \sqrt{\frac{2 * [ {( 0.5 dI )}^{2} + {( 1.5 dI )}^{2} + {( 3 dI )}^{2} + {( 5 dI )}^{2} + {( 7.5 dI )}^{2} + {( 10.5 dI )}^{2} + {( 14 dI )}^{2} ] + {( 18 dI )}^{2}}{16}} & ( 10 )\end{matrix}$$

As shown in equation (9) and equation (10), maximum unbalance of the current source is

$$\frac{- 32 dI}{8 I + 18 dI} * 100 \%$$

and maximum nonlinearity is 8.374 (dI).

After the current source is executed the interval exchange arrangement in Step 404 and the interval exchange in Step 406, substituting the above mentioned parameters of the current source in FIG. 5 into equation (3) and equation (4) can yield corresponding balance and linearity of the current source according to equation (11) and equation (12):

$$\begin{matrix}Unbalance = \frac{( 8 I + 2 dI ) - ( 8 I + 2 dI )}{( 8 I + 2 dI )} * 100 \% = 0 & ( 11 ) \\ {( INL )}_{rms} = \sqrt{\frac{[ {( - 0.5 dI )}^{2} + {( 0.5 dI )}^{2} + {( - 0.5 dI )}^{2} + {( 1 dI )}^{2} + {( - 1.5 dI )}^{2} + {( 1.5 dI )}^{2} + {( - 1.5 dI )}^{2} + {( 2 dI )}^{2} ]}{16}} + \sqrt{\frac{[ {( 0.5 dI )}^{2} + {( - 1 dI )}^{2} + {( 1 dI )}^{2} + {( - 1 dI )}^{2} + {( 1.5 dI )}^{2} + {( - 2 dI )}^{2} + {( 2 dI )}^{2} ]}{16}} & ( 12 )\end{matrix}$$

As shown in equation (11) and equation (12), unbalance of the current source is 0 and maximum nonlinearity is 1.275 (dI).

As shown in equation (5)-(12), unbalance and nonlinearity of the current source due to the process gradient can be improved by the interval exchange arrangement in Step 404 and the interval exchange in Step 406 provided by the present invention.

In another embodiment of the present invention (as shown in FIG. 6), in Step 408, install the two balance units 602 and 604 outside the two longer sides of the current cell row respectively after the positions of the current cells C1-C16 is determined according to the third sort L3. The two balance units 601 and 602 have the same pattern, where the two balance units 601 and 602 can be implemented through polysilicon, aluminum, copper, or diffusion layers.

In another embodiment of the present invention (as shown in FIG. 7), in Step 410, install the two current cells C17 and C18 at the two terminals of the current cell row, respectively, where the current cells C17 and C18 are dummy current cells which do not provide currents.

In the embodiment in FIG. 7, because the dummy current cells (the current cells C17 and C18), and balance units 702 and 704 are added to the current cell row, a layout environment of each current cell of the current cell row is the same, resulting in balance and linearity of the current cell row being further improved.

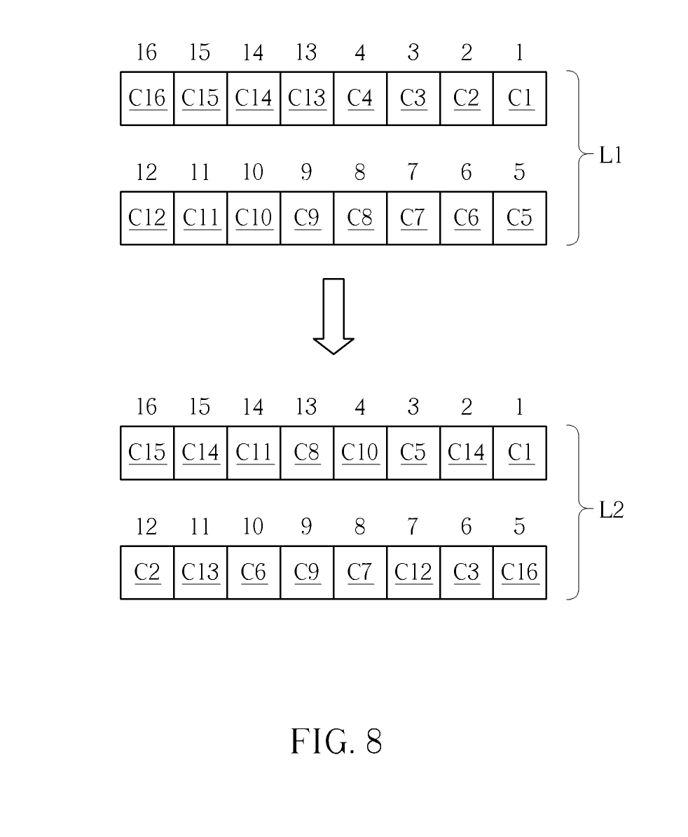

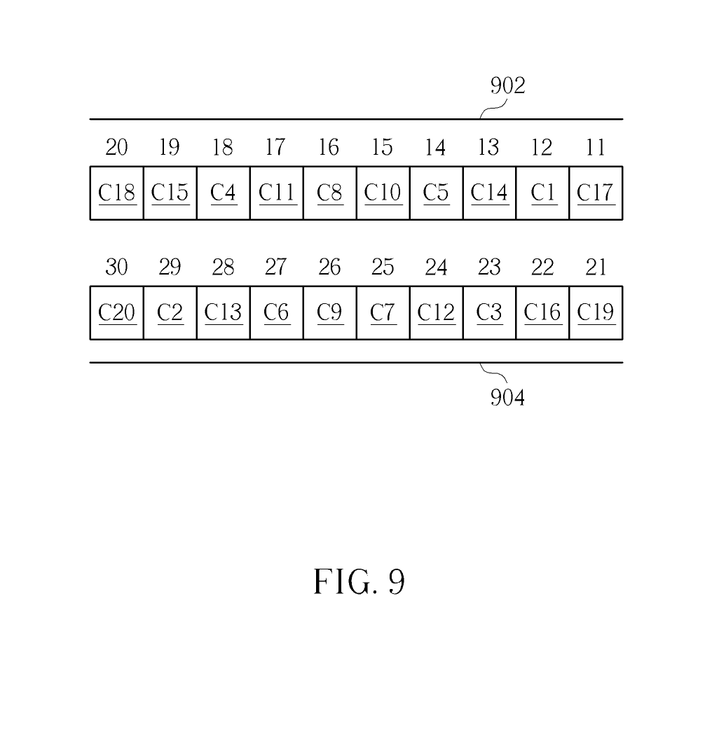

FIG. 8 and FIG. 9 are diagrams illustrating how to apply the present invention to a plurality of current cell rows according to another embodiment. As shown in FIG. 8, current cells C1-C16 are arranged two current cell rows to form a first sort L1. Meanwhile, each current cell of the current cells C1-C16 corresponds to a position. For example, the current cell C1 corresponds to a position 1, the current cell C2 corresponds to a position 2, and so on. In the embodiment, the current cells C1-C8 are used for providing a first current, and the current cells C9-C16 are used for providing a second current, where the first current is a positive current, and the second current is a negative current.

Current variation (represented as dI) of each current cell (providing a current I) of the current source in FIG. 8 from left to right due to process mismatch can be represented as parameters as follows:

I+−3dI, I+−2dI, I+−1dI, I, I+−1dI, I+−2dI, I+−3dI, I+−4d

I+−4dI, I+−3dI, I+−2dI, I+−1dI, I+−2dI, I+−3dI, I+−4d, I+−5d

Before the current source is executed the interval exchange arrangement in Step 404 and the interval exchange in Step 406, substituting the above mentioned parameters of the current source in FIG. 8 into equation (3) and equation (4) can yield corresponding balance and linearity of the current source according to equation (13) and equation (14):

$$\begin{matrix}Unbalance = \frac{( 8 I \pm 16 dI ) - ( 8 I \pm 24 dI )}{( 8 I \pm 24 dI )} * 100 \% & ( 13 ) \\ {( INL )}_{rms} = \sqrt{\frac{[ {( 2 dI )}^{2} + {( 5 dI )}^{2} + {( 9 dI )}^{2} + {( 14 dI )}^{2} + {( 15 dI )}^{2} + {( 17 dI )}^{2} + {( 20 dI )}^{2} + {( 24 dI )}^{2} ]}{16}} + \sqrt{\frac{[ {( 1 dI )}^{2} + {( 3 dI )}^{2} + {( 6 dI )}^{2} + {( 10 dI )}^{2} + {( 11 dI )}^{2} + {( 12 dI )}^{2} + {( 14 dI )}^{2} + {( 17 dI )}^{2} ]}{16}} & ( 14 )\end{matrix}$$

As shown in equation (13) and equation (14), maximum unbalance of the current source is

$$\frac{40 dI}{8 I - 24 dI} * 100 \%$$

and maximum nonlinearity is 12.971 (dI).

After the current source is executed the interval exchange arrangement in Step 404 and the interval exchange in Step 406, substituting the above mentioned parameters of the current source in FIG. 8 into equation (3) and equation (4) can yield corresponding balance and linearity of the current source according to equation (15) and equation (16):

$$\begin{matrix}Unbalance = \frac{( 8 I \pm 20 dI ) - ( 8 I \pm 20 dI )}{( 8 I \pm 20 dI )} * 100 \% & ( 15 ) \\ {( INL )}_{rms} = \sqrt{\frac{[ {( 0 dI )}^{2} + {( 2 dI )}^{2} + {( 4 dI )}^{2} + {( 6 dI )}^{2} + {( 8 dI )}^{2} + {( 12 dI )}^{2} + {( 16 dI )}^{2} + {( 20 dI )}^{2} ]}{16}} + \sqrt{\frac{[ {( 1 dI )}^{2} + {( 2 dI )}^{2} + {( 3 dI )}^{2} + {( 6 dI )}^{2} + {( 9 dI )}^{2} + {( 12 dI )}^{2} + {( 15 dI )}^{2} + {( 20 dI )}^{2} ]}{16}} & ( 16 )\end{matrix}$$

As shown in equation (15) and equation (16), maximum unbalance of the current source is

$$\frac{40 dI}{8 I - 20 dI} * 100 \%$$

and maximum nonlinearity is 10.665 (dI).

Current variation (represented as dI) of each current cell (providing the current I) of the current source in FIG. 8 from left to right due to process gradient can be represented as parameters as follows:

I−1.5dI, I−1dI, I−0.5dI, I, I+0.5dI, I+1dI, I+1.5dI, I+2dI

I-2dI, I−1.5dI, I'11dI, I−0.5dI, I, I+0.5dI, I+1dI, I+1.5dI

Before the current source is executed the interval exchange arrangement in Step 404 and the interval exchange in Step 406, substituting the above mentioned parameters of the current source in FIG. 8 into equation (3) and equation (4) can yield corresponding balance and linearity of the current source according to equation (17) and equation (18):

$$\begin{matrix}Unbalance = \frac{( 8 I - 8 dI ) - ( 8 I + 8 dI )}{( 8 I + 8 dI )} * 100 \% & ( 17 ) \\ {( INL )}_{rms} = \sqrt{\frac{[ {( 0 dI )}^{2} + {( 0.5 dI )}^{2} + {( 1.5 dI )}^{2} + {( 3 dI )}^{2} + {( 3.5 dI )}^{2} + {( 4.5 dI )}^{2} + {( 6 dI )}^{2} + {( 8 dI )}^{2} ]}{16}} + \sqrt{\frac{[ {( - 0.5 dI )}^{2} + {( - 1.5 dI )}^{2} + {( - 3 dI )}^{2} + {( - 5 dI )}^{2} + {( - 5 dI )}^{2} + {( - 5.5 dI )}^{2} + {( - 6.5 dI )}^{2} + {( - 8 dI )}^{2} ]}{16}} & ( 18 )\end{matrix}$$

As shown in equation (17) and equation (18), maximum unbalance of the current source is

$$\frac{- 16 dI}{8 I + 18 dI} * 100 \%$$

and maximum nonlinearity is 4.623 (dI).

After the current source is executed the interval exchange arrangement in Step 404 and the interval exchange in Step 406, substituting the above mentioned parameters of the current source in FIG. 8 into equation (3) and equation (4) can yield corresponding balance and linearity of the current source according to equation (19) and equation (20):

$$\begin{matrix}Unbalance = \frac{( 8 I + 0 dI ) - ( 8 I + 0 dI )}{( 8 I + 0 dI )} * 100 \% = 0 & ( 19 ) \\ {( INL )}_{rms} = \sqrt{\frac{[ {( 0 dI )}^{2} + {( 0 dI )}^{2} + {( - 1 dI )}^{2} + {( 0 dI )}^{2} + {( - 1 dI )}^{2} + {( 0 dI )}^{2} + {( - 2 dI )}^{2} + {( 0 dI )}^{2} ]}{16}} + \sqrt{\frac{[ {( - 0.5 dI )}^{2} + {( 0 dI )}^{2} + {( - 0.5 dI )}^{2} + {( 0 dI )}^{2} + {( - 1.5 dI )}^{2} + {( 0 dI )}^{2} + {( - 1.5 dI )}^{2} + {( 0 dI )}^{2} ]}{16}} & ( 20 )\end{matrix}$$

As shown in equation (11) and equation (12), unbalance of the current source is 0 and maximum nonlinearity is 0.829 (dI).

In another embodiment of the present invention (as shown in FIG. 9), in Step 408, install two balance units 902 and 904 outside two longer sides of the two current cell rows, and also install dummy current cells C17, C18, C19, and C20 at two terminals of each current cell row of the two current cell rows to make each current cell has the same layout environment. The two balance units 902 and 904 have the same pattern, where the two balance units 902 and 904 can be implemented through polysilicon, aluminum, copper, or diffusion layers.

To sum up, the method of arranging current cells of a current source provided by the present invention can effectively reduce unbalance and nonlinearity of the current source due to sizes, spacing, and direction gradient of the current cells of the current source, and can also prevent from utilizing numerous dummy current cells.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for arranging current cells of a current source, the method comprising:
sequentially arranging a plurality of current cells of the current source, so as to form a first sort;
executing interval exchange arrangement on the first sort to form a second sort according to characteristics of the plurality of current cells providing a first current or a second current;
executing interval exchange on the second sort to form a third sort; and
determining positions of the plurality of current cells to form a current cell row according to the third sort.

2. The method of claim 1, further comprising:
installing two balance units outside two longer sides of the current cell row respectively, wherein the two balance units have the same pattern.

3. The method of claim 2, wherein the two balance units are implemented through polysilicon, aluminum, copper, or diffusion layers.

4. The method of claim 1, further comprising:
installing two dummy current cells at two terminals of the current cell row, respectively.

5. The method of claim 1, wherein the first current is a positive current, and the second current is a negative current.

6. A method for arranging current cells of a current source, the method comprising:
arranging a plurality of current cells of the current source to M current cell rows so as to form a first sort, wherein each current cell row of the M current cell rows includes N current cells;
executing interval exchange arrangement on the first sort to form a second sort according to a characteristic of each current cell of the plurality of current cells providing a first current or a second current;
executing interval exchange on the second sort to form a third sort; and
determining positions of the plurality of current cells according to the third sort;
wherein M and N are positive integers greater than 1.

7. The method of claim 6, further comprising:
installing two balance units outside two longer sides of the M current cell rows, wherein the two balance units have the same pattern.

8. The method of claim 6, wherein the first current is a positive current, and the second current is a negative current.

9. The method of claim 7, wherein the two balance units are implemented through polysilicon, aluminum, copper, or diffusion layers.
